(19) United States
(12) Patent Application Publication
(10) Pub. No.: US 2020/0355928 A1
(43) Pub. Date: Nov. 12, 2020

(54) METHOD AND APPARATUS FOR ADJUSTING VR INTERPUPILLARY DISTANCE

(71) Applicant: GOERTEK INC., Weifang, Shandong (CN)

(72) Inventor: Tianrong DAI, Weifang (CN)

(73) Assignee: GOERTEK INC., Weifang, Shandong (CN)

(21) Appl. No.: 16/640,686

(22) PCT Filed: Jul. 31, 2018
(86) PCT No.: PCT/CN2018/097819

§ 371 Date: Feb. 20, 2020

(30) Foreign Application Priority Data
Aug. 23, 2017 (CN) 201710728127.9

(51) Int. Cl. G02B 27/01; G02B 27/00; G06T 19/00; G06T 7/73; G06T 7/00; G06F 3/01

(52) U.S. Cl. CPC G02B 27/0179; G02B 27/0093; G02B 27/0172; G06T 19/006; G06T 2207/30041; G06T 7/0012; G06F 3/013; G06F 3/017; G02B 2027/0138; G06T 7/74

(57) ABSTRACT

Disclosed in the present application are a method and an apparatus for adjusting a VR interpupillary distance, which comprise: determining position information of a center point of human eye pupil according to a human eye image; performing position matching between the position information of the center point of the human eye pupil and position information of a lens optical axis of a VR device; and when a matching result is inconsistent, adjusting a lens pitch of the VR device, such that a position of the lens optical axis of the VR device matches a position of the center point of the human eye pupil.

### CROSS-REFERENCE TO RELATED APPLICATIONS

The present application claims priority to Chinese Patent Application No. 201710728127.9, entitled “Method and Apparatus for Adjusting VR Interpupillary Distance”, filed on Aug. 23, 2017, which is hereby incorporated by reference in its entirety.

### FIELD

The present application relates to the field of virtual reality technology, and in particular, to a method and an apparatus for adjusting a VR interpupillary distance.

### BACKGROUND

Existing VR head mounted displays generally do not support interpupillary distance (IPD) adjustment, or only support manual adjustment. A VR head mounted display that does not support IPD adjustment has poor display clarity and anti-distortion effects when the interpupillary distance does not match, affecting the VR experience. VR head mounted display that only supports manual adjustment is subjectively adjusted by the user. The user determines whether the VR head mounted display that only supports manual adjustment has been adjusted to an appropriate position according to the visual effect the user sees. However, this subjective judgment is not accurate enough which often appears to adjust back and forth, and it is hard to judge whether it is in a proper position.

### SUMMARY

In view of this, the embodiment of the present application provides a method and an apparatus for adjusting a VR interpupillary distance for solving the technical problems described above, by which a lens axis pitch of a VR head mounted display may be adaptively adjusted according to different interpupillary distances of human eyes, to be adaptive to different interpupillary distances of human eyes and to ensure the best VR experience for different users.

The present application provides a method for adjusting a VR interpupillary distance, including:

determining position information of a center point of a human eye pupil according to a human eye image;

performing position information matching between the position information of the center point of the human eye pupil and position information of a lens optical axis of a VR device; and

when a matching result is inconsistent, adjusting a lens pitch of the VR device, such that a position of the lens optical axis of the VR device matches a position of the center point of the human eye pupil.

Optionally, the determining the position information of the center point of the human eye pupil according to the human eye image includes:

performing image processing on the human eye image to determine position information of a center point of a left eye pupil and position information of a center point of a right eye pupil.

Optionally, the performing the position information matching between the position information of the center point of the human eye pupil and the position information of the lens optical axis of the VR device, includes:

determining a first deviation according to the position information of the center point of the left eye pupil and position information of a left lens optical axis of the VR device;

determining a second deviation according to the position information of the center point of the right eye pupil and position information of a right lens optical axis of the VR device; and

determining the matching result is inconsistent, if a difference between the first deviation and the second deviation is not equal to 0.

Optionally, the method further includes:

if a difference by subtracting the first deviation from the second deviation is greater than 0, determining that an interpupillary distance of a human eye is greater than the lens pitch;

if the difference by subtracting the first deviation from the second deviation is less than 0, determining that the interpupillary distance of the human eye is less than the lens pitch;

where the interpupillary distance of the human eye is a distance between the center point of the left eye pupil and the center point of the right eye pupil;

the lens pitch is a distance between the left lens optical axis and the right lens optical axis.

Optionally, when the matching result is inconsistent, the adjusting the lens pitch of the VR device, such that the position of the lens optical axis of the VR device matches the position of the center point of the human eye pupil, includes:

if the lens pitch of the VR device is greater than a distance of the human eye pupil, determining a first adjustment distance, where the first adjustment distance is a distance of the lens pitch needed to be reduced, and reducing the distance of the lens pitch according to the first adjustment distance; or

if the lens pitch of the VR device is less than the distance of the human eye pupil, determining a second adjustment distance, where the second adjustment distance is a distance of the lens pitch needed to be increased, and increasing the distance of the lens pitch according to the second adjustment distance.

Optionally, a pixel position of a geometric center point of the human eye image is used to indicate a camera position, a recognized pixel position of a center point of a human eye pupil is used to indicate the position information of the center point of the human eye pupil, a horizontal distance between two pixels is represented by a quantity of pixel point, and correspondingly, a deviation of the distance is a difference between the quantity of the pixel point.

The present application further provides an apparatus for adjusting a VR interpupillary distance, including: a camera module, a processor, a memory and a drive motor; the processor is respectively connected to the memory, the camera module, and a drive motor; where the memory stores a program for realizing a VR interpupillary distance adjustment, and the processor executes the program for realizing the VR interpupillary distance adjustment stored in the memory;

the camera module is configured to take a human eye image and send the human eye image to the processor;

the processor is configured to when receives the human eye image sent by the camera module, call the program stored in the memory to recognize a human eye pupil from the human eye image and determine position information of a center point of a human eye pupil, perform position information matching between the position information of the center point of the human eye pupil and position information of a lens optical axis of a VR device, and when a matching result is inconsistent, send an adjustment instruction to the drive motor;

the drive motor is configured to adjust a lens pitch of the VR device according to the adjustment instruction, such that a position of the lens optical axis of the VR device matches a position of the center point of the human eye pupil.

Optionally, the camera module is provided below and outside a lens of the VR device, the camera module is located directly below an optical axis of the lens, the camera module is disposed on a side where the lens and the human eye are opposite to each other, and the camera module collects the human eye image regarding the human eye; or

the camera module is disposed between the lens and a display screen of the VR device, relative positions of the camera module and the lens and the display screen are fixed, which are connected into an integral structural module, a semi-transparent semi-reflecting lens is provided between the lens and the display screen, the camera module and the semi-transparent semi-reflecting lens are oppositely disposed, and the camera module collects the human eye image reflected by the human eye on the semi-reflecting lens through the lens.

Optionally, the position information of the center point of the human eye pupil determined by the processor includes position information of a center point of a left eye pupil and position information of a center point of a right eye pupil.

Optionally, when the processor calls the program stored in the memory, the processor is specifically configured to: determine a first deviation according to position information of a center point of a left eye pupil and position information of a left lens optical axis of the VR device; determine a second deviation according to position information of a center point of a right eye pupil and position information of a right lens optical axis of the VR device; and a matching result is inconsistent, if a difference between the first deviation and the second deviation is not equal to 0.

Optionally, when the processor calls the program stored in the memory, the processor is further specifically configured to:

if a difference by subtracting the first deviation from the second deviation is greater than 0, determine that an interpupillary distance of a human eye is greater than the lens pitch; and

if the difference by subtracting the first deviation from the second deviation is less than 0, determine that the interpupillary distance of the human eye is less than the lens pitch;

where the interpupillary distance of the human eye is a distance between the center point of the left eye pupil and the center point of the right eye pupil;

the lens pitch is a distance between the left lens optical axis and the right lens optical axis.

Optionally, the processor is further configured to determine a first adjustment distance when determining that the lens pitch of the VR device is greater than a distance of the human eye pupil, where the first adjustment distance is a distance of the lens pitch needed to be reduced, and send the adjustment instruction to the drive motor, such that the drive motor drives a right lens and a left lens to move towards each other by the first adjustment distance according to the adjustment instruction comprising the first adjustment distance; or

the processor is further configured to determine a second adjustment distance when determining that the lens pitch of the VR device is less than the distance of the human eye pupil, where the second adjustment distance is a distance of the lens pitch needed to be increased, and send the adjustment instruction to the drive motor, such that the drive motor drives the right lens and the left lens to move away from each other by the second adjustment distance according to the adjustment instruction comprising the second adjustment distance.

The present application provides a self-adaptive scheme of automatically adjustment the interpupillary distance (IPD) which combines software, hardware and structure. According to the self-adaptive scheme, the human eye pupil can be automatically identified and an interpupillary distance of the human eye can be calculated according to the human eye image, and a VR lens axis pitch is automatically adjusted according to the interpupillary distance of the human eye, such that the lens axis pitch and the interpupillary distance completely match. Thereby, the lens axis pitch can be objectively, quickly and accurately adjusted according to different interpupillary distances of human eyes, and the user experience is greatly improved consequently.

### BRIEF DESCRIPTION OF THE DRAWINGS

The drawings described herein are used to provide a further understanding of the present application and constitute a part of the present application. The example embodiments of the present application and the descriptions thereof are used to explain the present application, and do not constitute an improper limitation on the present application. In the drawings:

FIG. 1 is a schematic diagram of a VR lens center, a human eye pupil center, and a display screen center;

FIG. 2 is a schematic flowchart of a method for adjustment a VR interpupillary distance according to the present application;

FIG. 3 is a schematic diagram of a human eye image taken by a direct shooting way;

FIG. 4 is a schematic diagram of a human eye image taken by an infrared reflector;

FIG. 5 is a calculation diagram of a relationship between a lens axis pitch and an interpupillary distance;

FIG. 6 is another calculation diagram of a relationship between a lens axis pitch and an interpupillary distance;

FIG. 7 is still another calculation diagram of a relationship between a lens axis pitch and an interpupillary distance;

FIG. 8 is further another calculation diagram of a relationship between a lens axis pitch and an interpupillary distance;

FIG. 9 is a schematic structural diagram of adjusting a lens axis pitch; and

FIG. 10 is a schematic structural diagram of an apparatus for adjusting a VR interpupillary distance according to the present application.

### DETAILED DESCRIPTION OF EXAMPLE EMBODIMENTS

For making the purposes, technical solutions and advantages of the embodiments of the present invention clearer, the technical solutions in the embodiments of the present invention will be clearly and completely described below in combination with the drawings in the embodiments of the present invention. It is apparent that the described embodiments are not all embodiments but part of embodiments of the present invention. All other embodiments obtained by those of ordinary skill in the art on the basis of the embodiments in the present invention without creative work shall fall within the scope of protection of the present invention.

An interpupillary distance (IPD: interpupillary distance) refers to a distance between the pupils of two eyes, which varies from person to person. The range generally varies from 55 to 75 mm The interpupillary distance between different ages and races may even exceed the above range. For a VR head mounted display, whether an axial pitch of an optical lens is consistent with the user's interpupillary distance will greatly affect the user experience. When the axial pitch of the optical lens is inconsistent with the interpupillary distance of the user, that is, the pupil position deviates from the optical axis position of the lens, especially when the deviation is large, the sharpness of the screen image seen through the lens will be reduced. In addition, the anti-distortion processing of the VR lens is based on the assumption that the user's observation point is on the lens optical axis. When the observation point is far away from the lens optical axis, the effect of anti-distortion will be weakened a lot.

FIG. 1 is a schematic diagram of a VR lens center, a human eye pupil center, and a display screen center. As shown in FIG. 1, generally, the three points of the VR lens center, the human eye pupil center, and the display screen center are not on a straight line. At this time, the inconsistency between the axial pitch of the VR lens and the interpupillary distance of the user will cause the sharpness of the screen image seen by the user to decrease sharply. Therefore, the axial distance of the VR lens needs to be adjusted to suit the interpupillary distance of the user.

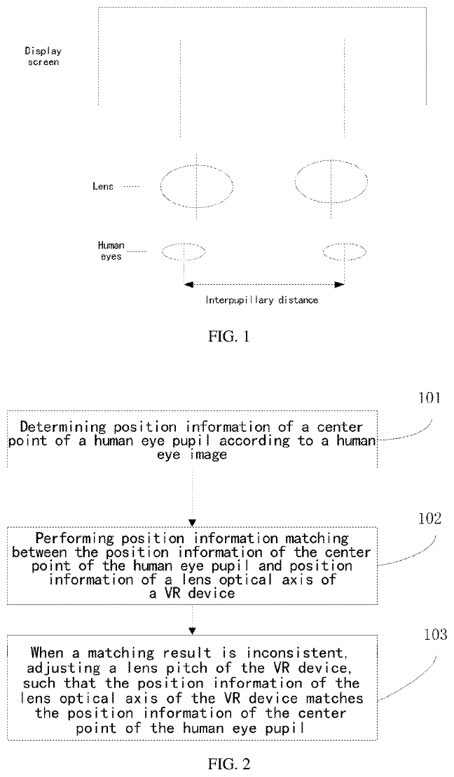

FIG. 2 is a schematic flowchart of a method for adjustment a VR interpupillary distance according to the present application. As shown in FIG. 2, the method includes:

101. determining position information of a center point of a human eye pupil according to a human eye image.

The human eye image is first acquired. In the present embodiment, the reason for taking the human eye image by disposing a camera directly below the optical axis of the VR lens is because it is not possible to determine whether an interpupillary distance of a human eye is too big or too small relative to the VR lens axis pitch before the human eye interpupillary distance is determined. By disposing the camera directly below the optical axis of the VR lens can best deal with the two extreme cases that VR lens axis pitch is too large or too small. Moreover, by disposing the camera directly below the optical axis of the VR lens to take the human eye image can minimize the calculation amount when calculating the human eye image, which does not need to be calibrated in advance, and is robust.

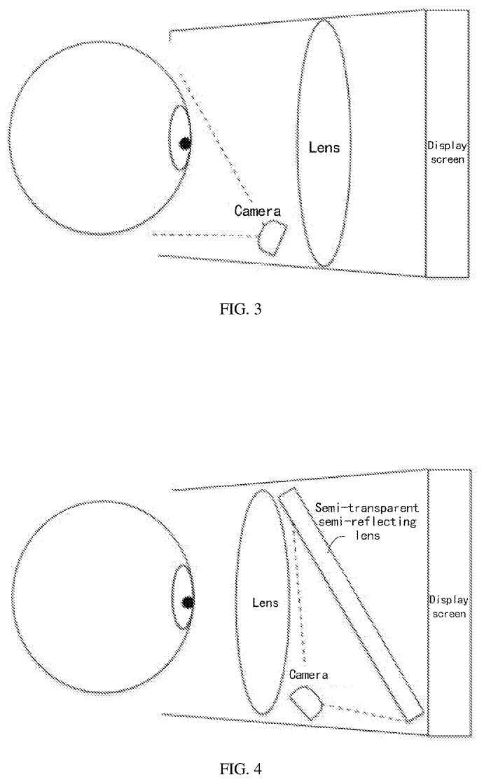

Considering that the human eye is in a closed space when wearing a VR head mounted display, an infrared LED light source needs to be provided around the lens, such that an infrared image of the human eye can be captured by the camera. There are two ways to shoot. One way is the direct shooting way. The camera is disposed below and outside the VR lens. FIG. 3 is a schematic diagram of a human eye image taken by a direct shooting way. The camera is disposed on a side where the lens and the human eye are opposite to each other, and the camera directly collects the human eye image regarding the human eye. The other way is to dispose the camera between the lens and the display screen, and shoot through an infrared reflector. FIG. 4 is a schematic diagram of a human eye image taken by an infrared reflector. A semi-transparent semi-reflecting lens is provided between the lens and the display screen, the camera and the semi-transparent semi-reflecting lens are oppositely disposed, and the camera collects the human eye image reflected by the human eye on the semi-reflecting lens through the lens.

No matter by which way, relative positions of the camera and the lens and the display screen are fixed, which are connected into an integral structural module.

Second, pupil recognition is performed through image processing based on the captured left and right eye images. Considering that the human eye does not always look straight ahead, and may squint to the left or the right, the inventor found in the process of implementing the present application that: no matter how the human eye moves, the actions of the left and right eyes are strictly synchronized, including blinking and turning, unless a person suffers from severely strabismus, such that the interpupillary distance of the user does not change no matter which direction the user looks. Therefore, on the basis of identifying the pupil, determining the position of the center point of the human eye pupil specifically includes position information of a center point of a left eye pupil and position information of a center point of a right eye pupil.

102. performing position information matching between the position information of the center point of the human eye pupil and position information of a lens optical axis of a VR device.

In an optional manner, a first deviation is determined according to the position information of the center point of the left eye pupil and position information of a left lens optical axis of the VR device; a second deviation is determined according to the position information of the center point of the right eye pupil and position information of a right lens optical axis of the VR device; and if a difference between the first deviation and the second deviation is not equal to 0, the matching result is determined as being inconsistent.

It should be noted that the distance and the deviation in the embodiment of the present application are both expressed in pixels. A pixel of a geometric center point of an image taken by the camera may be is used to indicate the position of the camera, a recognized pixel position of a center point of a pupil indicates the pupil position, a horizontal distance between the two pixels is represented by a quantity of pixel point, and correspondingly, a deviation of the distance is a difference between the quantity of the pixel point.

103. when a matching result is inconsistent, adjusting a lens pitch of the VR device, such that the position information of the lens optical axis of the VR device matches the position information of the center point of the human eye pupil.

Specifically, if the lens pitch of the VR device is greater than a distance of the human eye pupil, a first adjustment distance is determined. The first adjustment distance is a distance of the lens pitch needed to be reduced. The distance of the lens pitch is reduced according to the first adjustment distance. or

If the lens pitch of the VR device is less than the distance of the human eye pupil, a second adjustment distance is determined. The second adjustment distance is a distance of the lens pitch needed to be increased. The distance of the lens pitch is increased according to the second adjustment distance.

In the following, the relationship between the lens axis pitch and the interpupillary distance is explained in detail by examples.

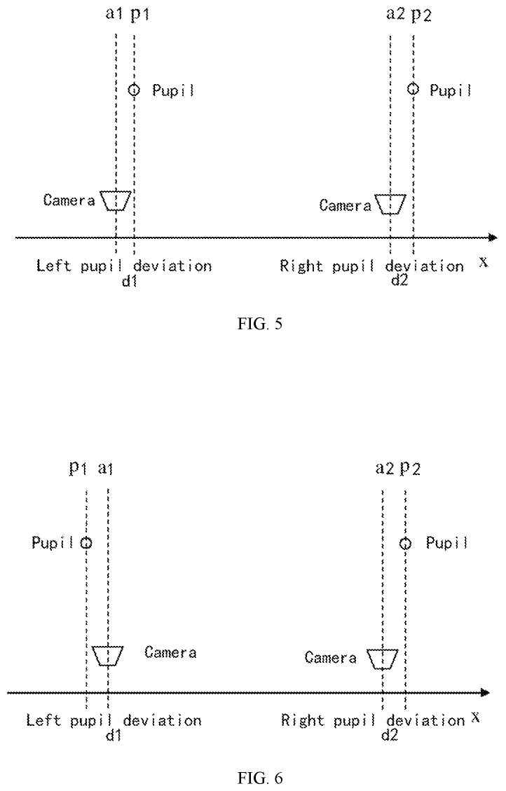

FIG. 5 is a calculation diagram of a relationship between a lens axis pitch and an interpupillary distance. As shown in FIG. 5, it is assumed that the left lens optical axis is on the left side of the center line of the left eye, and the right lens optical axis is on the left side of the center line of the right eye. At this time, the horizontal positions of the pupil centers of the left and right eyes are pl and p2 respectively, and the horizontal positions of the optical axis of the left and right lenses (also the horizontal position of the camera) are: al and a2, respectively. The deviations between the pupils of the left and right eyes and the optical axis of the left and right lenses may be calculated respectively as:

the first deviation d1=p1-a1, d1 is positive;

the second deviation d2=p2-a2, d2 is positive;

diff=d2-d1, if diff>0, the interpupillary distance (IPD)>lens axis pitch, if diff<0, IPD<lens axis pitch.

FIG. 6 is another calculation diagram of a relationship between a lens axis pitch and an interpupillary distance. As shown in FIG. 6, it is assumed that the left lens optical axis is on the right side of the center line of the left eye, and the right lens optical axis is on the left side of the center line of the right eye. At this time, the horizontal positions of the pupil centers of the left and right eyes are p1 and p2 respectively, and the horizontal positions of the optical axes of the left and right lenses (also the horizontal position of the camera) are: al and a2, respectively. The deviations between the pupils of the left and right eyes and the optical axis of the left and right lenses may be calculated respectively as:

the first deviation d1=p1-a1, d1 is negative;

the second deviation d2=p2-a2, d2 is positive;

diff=d2-d1, at this time, there is only one possibility, that is, diff>0, and at this time, the interpupillary distance (IPD)>lens axis pitch.

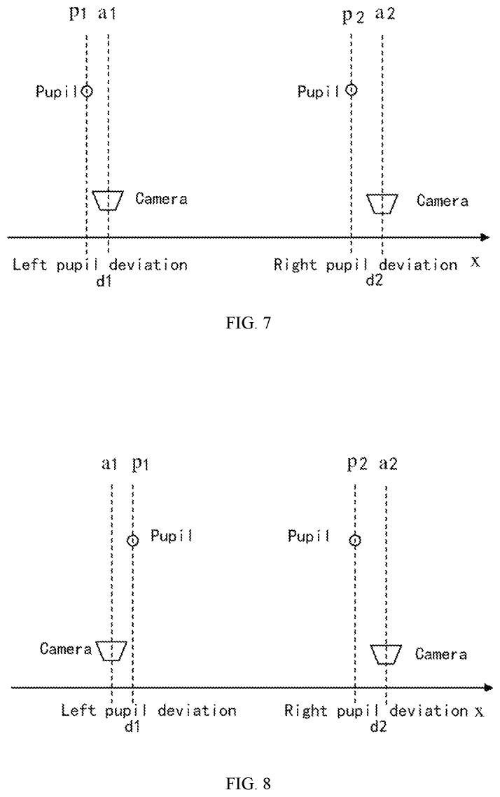

FIG. 7 is still another calculation diagram of a relationship between a lens axis pitch and an interpupillary distance. As shown in FIG. 7, it is assumed that the left lens optical axis is on the left side of the center line of the left eye, and the right lens optical axis is on the right side of the center line of the right eye. At this time, the horizontal positions of the pupil centers of the left and right eyes are p1 and p2 respectively, and the horizontal positions of the optical axes of the left and right lenses (also the horizontal position of the camera) are: a1 and a2, respectively. The deviations between the pupils of the left and right eyes and the optical axis of the left and right lenses may be calculated respectively as:

the first deviation d1=p1-a1, d1 is negative;

the second deviation d2=p2-a2, d2 is negative;

diff=d2-d1;

diff>0 (|d1|>|d2|) indicates: interpupillary distance (IPD)>lens axis pitch;

diff<0 (|d1|<|d2|) indicates: interpupillary distance (IPD)<lens axis pitch.

FIG. 8 is further another calculation diagram of a relationship between a lens axis pitch and an interpupillary distance. As shown in FIG. 8, it is assumed that the left lens optical axis is on the left side of the center line of the left eye, and the right lens optical axis is on the right side of the center line of the right eye. At this time, the horizontal positions of the pupil centers of the left and right eyes are p1 and p2 respectively, and the horizontal positions of the optical axes of the left and right lenses (also the horizontal position of the camera) are: al and a2, respectively. The deviations between the pupils of the left and right eyes and the optical axis of the left and right lenses may be calculated respectively as:

the first deviation d1=p1-a1, d1 is positive;

the second deviation d2=p2-a2, d2 is negative;

diff=d2-d1, at this time, there is only one possibility, that is, diff<0, and at this time, the interpupillary distance (IPD)<lens axis pitch.

Therefore, we can get from FIG. 5 to FIG. 8: diff=d2-d1, if diff is positive, it indicates that the lens axis pitch is smaller than the interpupillary distance; if diff is 0, it indicates that the lens axis pitch is equal to the interpupillary distance; and if diff is negative, it indicates that the lens axis pitch is larger than the interpupillary distance.

Therefore, when performing the position matching in the above step 102, the method further includes:

if a difference by subtracting the first deviation from the second deviation is greater than 0, determining that an interpupillary distance of a human eye is greater than the lens pitch;

if the difference by subtracting the first deviation from the second deviation is less than 0, determining that the interpupillary distance of the human eye is less than the lens pitch;

where the interpupillary distance of the human eye is a distance between the center point of the left eye pupil and the center point of the right eye pupil;

the lens pitch is a distance between the left lens optical axis and the right lens optical axis.

In the embodiment of the present application, the lens pitch of the VR device is adjusted such that the position information of the lens optical axis of the VR device matches the position information of the center point of the human eye pupil. In specific implementation, a motor can be driven to adjust the lens axis pitch by software instructions.

There are many structural solutions of adjusting the lens pitch. FIG. 9 is a schematic structural diagram of adjusting a lens axis pitch. As shown in FIG. 9, a screw is driven by the motor. There are two types of rotation of the screw: forward and reverse, which are corresponding to two movement modes of the lens module (including display screen, camera, and lens): gather or separate, respectively. The specific corresponding way depends on the structural design.

According to the difference between the diff values calculated in the relationship between the lens axial pitch and the interpupillary distance shown in FIG. 5 to FIG. 8, different motor driving methods are performed. If diff is 0, no adjustment is made, at this time, the lens axis pitch is exactly equal to the interpupillary distance. If diff is positive, it indicates that the lens axis pitch is too small, and the motor is needed to be driven to increase the lens axis pitch by a certain step (such as 1 mm), to increase the lens axis pitch. If diff is negative, it indicates that the lens axis pitch is too large, and the motor is needed to be driven to reduce the lens axis pitch by a certain step, to reduce the lens axis pitch. Steps 101 to 103 are loop executed, until diff is 0, that is, a matching state in which the lens axial pitch and the interpupillary distance are completely equal. The loop adjustment speed is determined by the speed of the motor drive. Generally, the speed of each camera shooting and software calculation is very fast, which may be completed in tens of milliseconds.

The present application provides a self-adaptive scheme of automatically adjustment the interpupillary distance (IPD) which combines software, hardware and structure. According to the self-adaptive scheme, the human eye pupil can be automatically identified and an interpupillary distance of the human eye can be calculated according to the human eye image, and a VR lens axis pitch is automatically adjusted according to the interpupillary distance of the human eye, such that the lens axis pitch and the interpupillary distance completely match. Thereby, the lens axis pitch can be objectively, quickly and accurately adjusted according to different interpupillary distances of human eyes, and the user experience is greatly improved consequently.

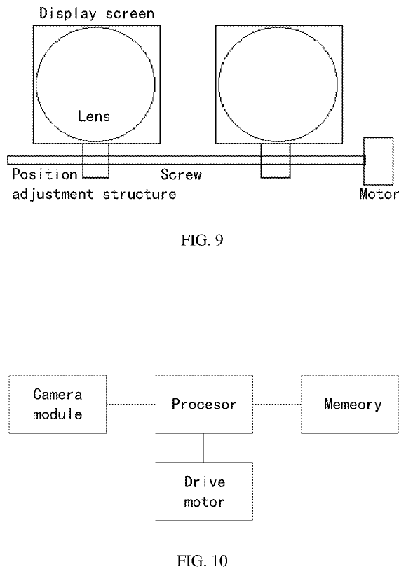

FIG. 10 is a schematic structural diagram of an apparatus for adjusting a VR interpupillary distance according to the present application. As shown in FIG. 10, the apparatus includes a camera module, a processor, a memory and a drive motor; the processor is respectively connected to the memory, the camera module, and a drive motor; where the memory stores a program for realizing a VR interpupillary distance adjustment, and the processor executes the program for realizing the VR interpupillary distance adjustment stored in the memory.

The camera module is configured to take a human eye image and send the human eye image to the processor.

Optionally, the camera module is provided below and outside a lens of the VR device, the camera module is located directly below an optical axis of the lens, the camera module is disposed on a side where the lens and the human eye are opposite to each other, and the camera module collects the human eye image regarding the human eye; or

the camera module is disposed between the lens and a display screen of the VR device, relative positions of the camera module and the lens and the display screen are fixed, which are connected into an integral structural module, a semi-transparent semi-reflecting lens is provided between the lens and the display screen, the camera module and the semi-transparent semi-reflecting lens are oppositely disposed, and the camera module collects the human eye image reflected by the human eye on the semi-reflecting lens through the lens.

When the processor receives the human eye image sent by the camera module, it calls the program stored in the memory and performs the following steps:

recognizing a human eye pupil from the human eye image and determining position information of a center point of a human eye pupil; performing position information matching between the position information of the center point of the human eye pupil and position information of a lens optical axis of a VR device, and when a matching result is inconsistent, sending an adjustment instruction to the drive motor.

The drive motor is configured to adjust a lens pitch of the VR device according to the adjustment instruction, such that a position of the lens optical axis of the VR device matches a position of the center point of the human eye pupil.

The position information of the center point of the human eye pupil determined by the processor includes position information of a center point of a left eye pupil and position information of a center point of a right eye pupil.

When the processor calls the program stored in the memory, the processor is specifically configured to: determine a first deviation according to position information of a center point of a left eye pupil and position information of a left lens optical axis of the VR device; determine a second deviation according to position information of a center point of a right eye pupil and position information of a right lens optical axis of the VR device; and a matching result is inconsistent, if a difference between the first deviation and the second deviation is not equal to 0.

When the processor calls the program stored in the memory, the processor is further specifically configured to:

if a difference by subtracting the first deviation from the second deviation is greater than 0, determine that an interpupillary distance of a human eye is greater than the lens pitch; and

if the difference by subtracting the first deviation from the second deviation is less than 0, determine that the interpupillary distance of the human eye is less than the lens pitch;

where the interpupillary distance of the human eye is a distance between the center point of the left eye pupil and the center point of the right eye pupil;

the lens pitch is a distance between the left lens optical axis and the right lens optical axis.

The processor is further configured to determine a first adjustment distance when determining that the lens pitch of the VR device is greater than a distance of the human eye pupil, where the first adjustment distance is a distance of the lens pitch needed to be reduced, and send the adjustment instruction to the drive motor, such that the drive motor drives a right lens and a left lens to move towards each other by the first adjustment distance according to the adjustment instruction comprising the first adjustment distance; or

the processor is further configured to determine a second adjustment distance when determining that the lens pitch of the VR device is less than the distance of the human eye pupil, where the second adjustment distance is a distance of the lens pitch needed to be increased, and send the adjustment instruction to the drive motor, such that the drive motor drives the right lens and the left lens to move away from each other by the second adjustment distance according to the adjustment instruction comprising the second adjustment distance.

The apparatus according to the embodiment of the present application may execute the method shown in FIG. 2, and its implementation principles and technical effects are not described repeatedly.

Those skilled in the art should know that the embodiment of the present invention may be provided as a method, a system or a computer program product. Therefore, the present invention may adopt a form of pure hardware embodiment, pure software embodiment and combined software and hardware embodiment. Moreover, the present invention may adopt a form of computer program product implemented on one or more computer-available storage media (including, but not limited to, a disk memory, a Compact Disc Read-Only Memory (CD-ROM) and an optical memory) including computer-available program codes.

The present invention is described with reference to flowcharts and/or block diagrams of the method, a device (system) and computer program product according to the embodiment of the present invention. It is to be understood that each flow and/or block in the flowcharts and/or the block diagrams and combinations of the flows and/or blocks in the flowcharts and/or the block diagrams may be implemented by computer program instructions. These computer program instructions may be provided for a universal computer, a dedicated computer, an embedded processor or a processor of another programmable data processing device to generate a machine, so that an apparatus for realizing a function specified in one flow or more flows in the flowcharts and/or one block or more blocks in the block diagrams is generated by the instructions executed through the computer or the processor of the other programmable data processing device.

These computer program instructions may also be stored in a computer-readable memory capable of guiding the computer or the other programmable data processing device to work in a specific manner, so that a product including an instruction apparatus may be generated by the instructions stored in the computer-readable memory, the instruction apparatus realizing the function specified in one flow or many flows in the flowcharts and/or one block or many blocks in the block diagrams.

These computer program instructions may further be loaded onto the computer or the other programmable data processing device, so that a series of operating steps are executed on the computer or the other programmable data processing device to generate processing implemented by the computer, and steps for realizing the function specified in one flow or many flows in the flowcharts and/or one block or many blocks in the block diagrams are provided by the instructions executed on the computer or the other programmable data processing device.

In a typical configuration, a computing device includes one or more processors (CPUs), an input/output interface, a network interface, and a memory.

The memory may include a non-permanent memory, a random access memory (RAM), and/or a non-volatile memory in a computer-readable medium, such as a read-only memory (ROM) or a flash RAM. The memory is an example of a computer-readable medium.

The computer-readable medium includes permanent and non-permanent, mobile and non-mobile media, which may implement information storage by any method or technology. The information may be a computer-readable instruction, a data structure, a program module, or other data. Examples of computer storage media include, but are not limited to, a phase change RAM (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disk read-only memory (CD-ROM), a digital versatile disk (DVD) or other optical memories, a magnetic tape cartridge, a magnetic tape storage device or other magnetic storage devices or any other non-transmission media, which may be used to store information accessible by a computing device. As defined herein, the computer-readable medium does not include non-transitory computer-readable media such as modulated data signals and carrier waves.

It is also to be noted that terms “include”, “contain” or any other variants thereof are intended to include nonexclusive inclusions, thereby ensuring that a commodity or system including a series of elements not only includes those elements but also includes other elements which are not clearly listed or further includes elements intrinsic to the commodity or the system. Under the condition of no more restrictions, an element defined by statement “including a/an” does not exclude existence of another element which is the same in a commodity or system including the element.

Those skilled in the art should know that the embodiment of the present invention may be provided as a method, a system or a computer program product. Therefore, the present invention may adopt a form of pure hardware embodiment, pure software embodiment and combined software and hardware embodiment. Moreover, the present invention may adopt a form of computer program product implemented on one or more computer-available storage media (including, but not limited to, a disk memory, a Compact Disc Read-Only Memory (CD-ROM) and an optical memory) including computer-available program codes.

The above is only the embodiment of the present disclosure and not intended to limit the present disclosure. Those skilled in the art may make various modifications and variations to the present disclosure. Any modifications, equivalent replacements, improvements and the like made within the spirit and principle of the present disclosure shall fall within the scope of the claims of the present disclosure.

What is claimed is:

1. A method for adjusting a VR interpupillary distance, comprising:
determining position information of a center point of a human eye pupil according to a human eye image;
performing position information matching between the position information of the center point of the human eye pupil and position information of a lens optical axis of a VR device; and
when a matching result is inconsistent, adjusting a lens pitch of the VR device, such that a position of the lens optical axis of the VR device matches a position of the center point of the human eye pupil.

2. The method for adjusting the VR interpupillary distance according to claim 1, wherein the determining the position information of the center point of the human eye pupil according to the human eye image comprises:
performing image processing on the human eye image to determine position information of a center point of a left eye pupil and position information of a center point of a right eye pupil.

3. The method for adjusting the VR interpupillary distance according to claim 2, wherein the performing the position information matching between the position information of the center point of the human eye pupil and the position information of the lens optical axis of the VR device, comprises:
determining a first deviation according to the position information of the center point of the left eye pupil and position information of a left lens optical axis of the VR device;
determining a second deviation according to the position information of the center point of the right eye pupil and position information of a right lens optical axis of the VR device; and
determining the matching result is inconsistent, if a difference between the first deviation and the second deviation is not equal to 0.

4. The method for adjusting the VR interpupillary distance according to claim 3, further comprising:
if a difference by subtracting the first deviation from the second deviation is greater than 0, determining that an interpupillary distance of a human eye is greater than the lens pitch;
if the difference by subtracting the first deviation from the second deviation is less than 0, determining that the interpupillary distance of the human eye is less than the lens pitch;
wherein the interpupillary distance of the human eye is a distance between the center point of the left eye pupil and the center point of the right eye pupil;
the lens pitch is a distance between the left lens optical axis and the right lens optical axis.

5. The method for adjusting the VR interpupillary distance according to claim 3, wherein when the matching result is inconsistent, the adjusting the lens pitch of the VR device, such that the position of the lens optical axis of the VR device matches the position of the center point of the human eye pupil, comprises:
if the lens pitch of the VR device is greater than a distance of the human eye pupil, determining a first adjustment distance, wherein the first adjustment distance is a distance of the lens pitch needed to be reduced, and reducing the distance of the lens pitch according to the first adjustment distance; or
if the lens pitch of the VR device is less than the distance of the human eye pupil, determining a second adjustment distance, wherein the second adjustment distance is a distance of the lens pitch needed to be increased, and increasing the distance of the lens pitch according to the second adjustment distance.

6. The method for adjusting the VR interpupillary distance according to claim 3, wherein:
a pixel position of a geometric center point of the human eye image is used to indicate a camera position, a recognized pixel position of a center point of a human eye pupil is used to indicate the position information of the center point of the human eye pupil, a horizontal distance between two pixels is represented by a quantity of pixel point, and correspondingly, a deviation of the distance is a difference between the quantity of the pixel point.

7. An apparatus for adjusting a VR interpupillary distance, comprising:
a camera module, a processor, a memory and a drive motor; the processor is respectively connected to the memory, the camera module, and a drive motor; wherein the memory stores a program for realizing a VR interpupillary distance adjustment, and the processor executes the program for realizing the VR interpupillary distance adjustment stored in the memory;
the camera module is configured to take a human eye image and send the human eye image to the processor;
the processor is configured to when receives the human eye image sent by the camera module, call the program stored in the memory to recognize a human eye pupil from the human eye image and determine position information of a center point of a human eye pupil, perform position information matching between the position information of the center point of the human eye pupil and position information of a lens optical axis of a VR device, and when a matching result is inconsistent, send an adjustment instruction to the drive motor;
the drive motor is configured to adjust a lens pitch of the VR device according to the adjustment instruction, such that a position of the lens optical axis of the VR device matches a position of the center point of the human eye pupil.

8. The apparatus for adjusting a VR interpupillary distance according to claim 6, wherein the camera module is provided below and outside a lens of the VR device, the camera module is located directly below an optical axis of the lens, the camera module is disposed on a side where the lens and the human eye are opposite to each other, and the camera module collects the human eye image regarding the human eye.

9. The apparatus for adjusting a VR interpupillary distance according to claim 7, wherein when the processor calls the program stored in the memory, the processor is specifically configured to:
determine a first deviation according to position information of a center point of a left eye pupil and position information of a left lens optical axis of the VR device; determine a second deviation according to position information of a center point of a right eye pupil and position information of a right lens optical axis of the VR device; and a matching result is inconsistent, if a difference between the first deviation and the second deviation is not equal to 0;
if a difference by subtracting the first deviation from the second deviation is greater than 0, determine that an interpupillary distance of a human eye is greater than the lens pitch; and
if the difference by subtracting the first deviation from the second deviation is less than 0, determine that the interpupillary distance of the human eye is less than the lens pitch;
wherein the interpupillary distance of the human eye is a distance between the center point of the left eye pupil and the center point of the right eye pupil;
the lens pitch is a distance between the left lens optical axis and the right lens optical axis.

10. The apparatus for adjusting a VR interpupillary distance according to claim 9, wherein:
the processor is further configured to determine a first adjustment distance when determining that the lens pitch of the VR device is greater than a distance of the human eye pupil, wherein the first adjustment distance is a distance of the lens pitch needed to be reduced, and send the adjustment instruction to the drive motor, such that the drive motor drives a right lens and a left lens to move towards each other by the first adjustment distance according to the adjustment instruction comprising the first adjustment distance; or
the processor is further configured to determine a second adjustment distance when determining that the lens pitch of the VR device is less than the distance of the human eye pupil, wherein the second adjustment distance is a distance of the lens pitch needed to be increased, and send the adjustment instruction to the drive motor, such that the drive motor drives the right lens and the left lens to move away from each other by the second adjustment distance according to the adjustment instruction comprising the second adjustment distance.

11. The apparatus for adjusting a VR interpupillary distance according to claim 6, wherein the camera module is disposed between the lens and a display screen of the VR device, relative positions of the camera module and the lens and the display screen are fixed, which are connected into an integral structural module, a semi-transparent semi-reflecting lens is provided between the lens and the display screen, the camera module and the semi-transparent semi-reflecting lens are oppositely disposed, and the camera module collects the human eye image reflected by the human eye on the semi-reflecting lens through the lens.
